(19) United States
(12) Patent Application Publication
(10) Pub. No.: US 2015/0264001 A1
(43) Pub. Date: Sep. 17, 2015

(54) SYSTEM AND METHOD FOR CONTACT MANAGEMENT

(71) Applicant: 8318808 Canada Inc., Milton (CA)

(72) Inventor: Neeraj GARG, Milton (CA)

(21) Appl. No.: 14/205,954

(22) Filed: Mar. 12, 2014

(51) Int. Cl. H04L 12/58; H04W 4/14; H04M 1/725

(52) U.S. Cl. CPC H04L 51/18; H04M 1/72519; H04W 4/14

(57) ABSTRACT

A system and method for contact management. The system comprises a contact management application or service. Each user is responsible for updating her own contact information locally, using a contact management application on a computing device, or via a contact management service available as a cloud service. The updated contact information is disseminated to one or more contacts that have previously requested to receive contact updates from the particular user and have been approved by the user to receive such updates. Contacts that have not received such approval are not provided with the updated contact information.

### TECHNICAL FIELD

The following relates generally to managing contact lists on computing devices and more specifically to selective automated updating of contact information.

### BACKGROUND

Many individuals have more than one mailing address, telephone number, email address, instant messaging identifier and other communications contact mechanisms. Quite commonly, a new service becomes available to users, which displaces the use of now-antiquated systems. For example, new instant messaging applications can become available on a particular mobile device platform and render prior existing instant messaging applications as redundant.

When users adopt new applications and services, there is generally a long process for alerting the user's various contacts that (a) she has adopted the new application or service; (b) the particular username or identifier through which she can be contacted on that application or service; and (c) that she has abandoned the use of some previously used competing service.

In other examples, sometimes a user abandons a prior service as a means by which to cease communication with others. However, the user still has to alert her friends and contacts (those with which she hopes to continue communicating) of her new contact information.

In other examples, sometimes a user adopts a new technology and uses it without abandoning other platforms.

Current electronic (computerized) contact management typically follows two paths: one being managed by centrally by the user and disseminated to her contacts on a periodic or real time basis, and the other being managed by her contacts on an individual basis. The latter, for example, includes having a contact list of others on one's mobile phone and manually adding or deleting contact identifiers (e.g., phone numbers) on an ad-hoc basis when alerted offline that such updating is needed.

An issue with the former is that it is difficult for the user to cease communication with undesirable contacts. An issue with the latter is the effort necessary to alert each of her contacts when she changes one of her many contact identifiers, adds a new one, or removes one.

### SUMMARY

In one aspect, a system for managing contacts on a computing device is provided, the computing device comprising a processor and memory, the memory storing computer instructions which when executed by the processor cause the processor to provide a contact management application, the computing device further in network communication with one or more additional computing devices, the contact management application configured to communicate contact information updates to selected ones of the additional computing devices corresponding to contacts for which a user of the computing device has approved for the contact information updates to be sent.

In another aspect, a method for managing contacts on a computing device is provided, the computing device comprising a processor and memory, the memory storing computer instructions which when executed by the processor cause the processor to with one or more additional computing devices, the method comprising: receiving a request from at least one additional computing device in network communication with the computing device, the at least one additional computing device corresponding to at least one contact; enabling a user of the computing device to selectively approve of communicating contact information updates to the at least one additional computing device; and communicating contact information updates to the selected ones of the additional computing devices corresponding to contacts for which a user of the computing device has approved for the contact information updates to be sent.

### BRIEF DESCRIPTION OF THE DRAWINGS

The features of the invention will become more apparent in the following detailed description in which reference is made to the appended drawings wherein:

FIG. 1 is an architecture diagram of a system for contact management;

FIG. 2 is a flowchart depicting a method for contact management; and

FIG. 3 is a flowchart depicting updating contact information.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

The following provides a system and method for contact management. The system comprises a contact management application or service. Each user is responsible for updating her own contact information locally, using a contact management application on a computing device, or via a contact management service available as a cloud service. The updated contact information is disseminated to one or more contacts that have previously requested to receive contact updates from the particular user and have been approved by the user to receive such updates. Contacts that have not received such approval are not provided with the updated contact information.

In the following, “user” refers to a user who is in control of her own contact information and from who other individuals would like to receive contact information updates; “contact” refers to any of those other individuals; and “contact information” refers to any aspect of contact information including, but not limited to, mailing address, phone number, fax number, email address, instant messaging ID, proprietary messaging medium ID, social network ID, etc.

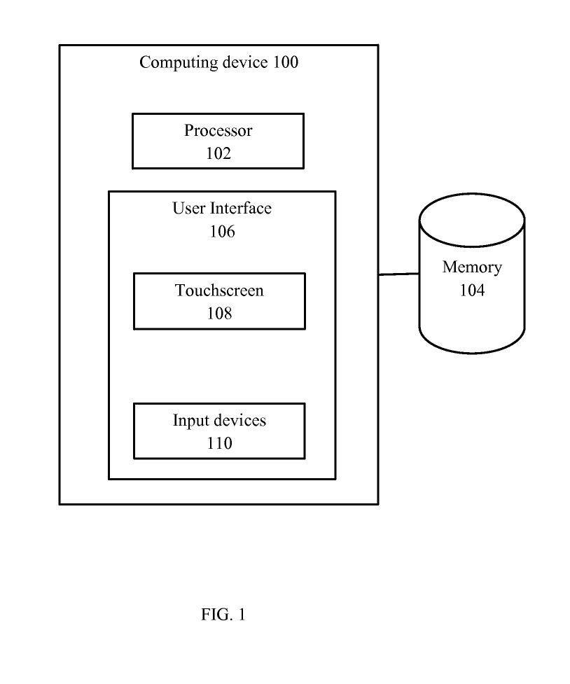

Referring first to FIG. 1, an exemplary contact management application is illustrated as executable upon a computing device (100). The computing device (100 may, for example, by a PC, laptop, tablet, smartphone or other device having a processor (102) and memory (104), the memory (104) having stored thereon computer instructions which when executed by the processor (102) cause the following operations to be performed. The contact management application further stores and retrieves contact information and contact update flags to the memory.

The computing device (100) further comprises a user interface (106) comprising an input device (110) such as a keyboard, mouse or touchscreen and an output device (108) such as a monitor or other display, for example a touchscreen

The contact management application enables the user to (a) manage her own contact information across a plurality of communications platforms using a contact management interface, as is known, which enables the user to input their own contact information including a plurality mailing addresses, phone numbers, email addresses, instant messaging addresses, fax numbers, social media handles, website addresses, etc.; (b) request contact information updates from other contacts; and (c) approval and rejection of requests for contact informations updates received from other contacts.

Preferably, the contact management application is also used by the user to view and use contact information for her contacts; that is, it is also an address book. Otherwise, the contact management application could interface with an address book using, for example, an application programming interface (API) provided by the contact management application or by the address book application.

The contact management application exchanges update requests and approvals by communicating via a network connection, such as the internet, with corresponding contact management applications managed by other contacts, each of whom may operate a respective contact management application providing similar functionality. Communication between users and contacts may be accomplished via peer-to-peer communication between their respective computing devices and/or specifically via their respective contact management applications, or through a hosted communication exchange (e.g., through a server). Alternatively, communication may be enabled via short messaging service (SMS), preferably equipped with code exchange for authentication, including by a public or private key infrastructure. In embodiments where a server host is used, the server may provide caching and/or scheduled delivery of updates and requests, for example for load balancing or in cases where the target computing device is not available/online.

Alternatively, contact management may be provided via a contact management service hosted in the cloud. Users and their contacts may each be provided with authentication credentials (e.g., user names and passwords) with which to access the contact management service. Communications in this embodiment can be handled by any protocol, including proprietary, operative on the service.

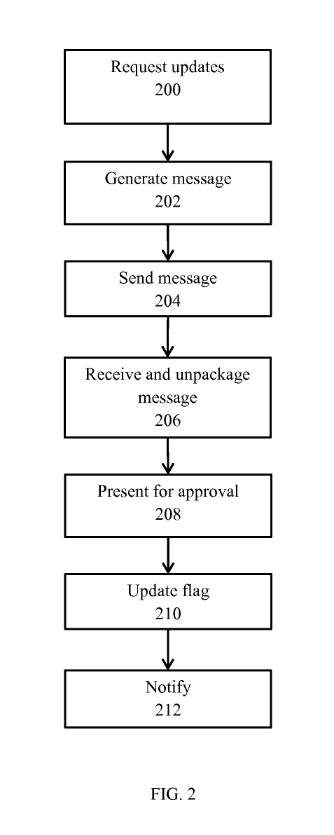

Referring now to FIG. 2, an exemplary workflow for managing and updating contact information is provided. In block 200, a plurality of users A, B and C have accessed their respective contact management applications (or service) and used it to establish respective contact records comprising their respective contact information. For the purposes of this example, user A will be referred to as a “user” while users B and C are that user's “contacts”.

In block 200, contact B may further initiate a request to user A to receive contact information updates from user A. The request may be initiated by contact B manually at any particular time, or through a scheduled and/or period automatically generated trigger, for example on a yearly basis. It will be appreciated that batch requesting (i.e., requesting updates from all users in contact B's address book or all users of a specific group in contact B's address book) is more easily accomplished where the requests are sent periodically.

In block 202, a message is generated by the contact management application for contact B identifying that it (a) originated from contact B and (b) requests contact information updates from user A. The message may further identify the means by which the message was generated, i.e., in this case that it was generated by contact B's corresponding contact management application.

The contact management application may suppress sending the request in particular cases including, for example, where the request was previously rejected by user A (if contact B was notified of such a rejection), or where updated information was recently received from user A and hence unlikely to have changed since (for example, in the last 1 or 2 months). In the latter case, the contact management application may store the request for sending at a later date.

In block 204, the message is communicated to the contact management application for user A. In block 206, the contact management application for user A receives the message, unpackages it to determine that it (a) originated from contact B; (b) requested contact information updates from user A and (c) optionally, that it was generated by contact B's contact management application.

In block 208, user A's contact management application presents user A via the output device with a prompt to either approve or reject the request from contact B. Contact B may or may not be previously listed in contact A's address book. If user A approves the request, a contact update flag is stored in memory by the contact management application indicating that contact B is to be alerted of modifications to user A's contact information as entered by user A in her contact management application. The flag further signals to user A's contact management application that it is not necessary to alert user A of further such requests from contact B. If user A's contact management application has determined that the message from contact B was generated by contact B's contact management application, user A's contact management application may further store that updates should be sent in a manner suitable for reading by contact B's contact management application. If contact A's address book previously listed contact B, then acceptance of the request may be linked to that contact. However, if contact B is not previously listed in the contact A's address book, then acceptance may be linked to a new listing for contact B using one or more of the following: contact B's unique identifier as included in the request or channel information by which the request came in, such as email or SMS.

In block 210, if user A rejects the request, either a negative contact update flag can be stored in memory by the contact management application indicating that contact B is not to be alerted of modifications to user A's contact information, or no flag need be set and default behaviour of not alerting of updates can be used. The flag further signals to user A's contact management application that it is not necessary to alert user A of further such requests from contact B. Similarly, contact C may request to receive user A's contact information updates. If contact A's address book contains contact C, then rejection of the request may be linked to that contact. However, if contact C is not present in the contact A's address book, then rejection may be linked using one or more of the following: contact C's unique identifier present in the request or channel information by which the request came in, such as email or SMS.

In various embodiments, contact B having initiated the request for updates from user A may or may not be notified of whether such a request is approved, rejected or ignored. Further, such notifications may be dependent upon whether user A desires such notification to be sent and/or whether contact B requests such a notification. Block 212 assumes notification is provided.

In various embodiments, both blocks 208 and 210 may trigger a reverse contact update or contact add request. In the case of a reverse contact update, contact A may choose to request, either manually or automatically, contact B and/or contact C for an information update if user A's contact management application indicates that contact B and/or contact C's information was updated a very long time ago (e.g., more than a year ago or some configurable period of time). Reverse update requests may only be sent to contacts that are already listed in the address book. In cases where either or both contact B and/or contact C are not listed in contact A's address book, contact A may choose to request, either manually or automatically, contact B and/or contact C for a full information update or contact add request. Should the contact(s) receiving the request decide to approve the incoming request, a new entry for the respective contact's information will be created in contact A's address book.

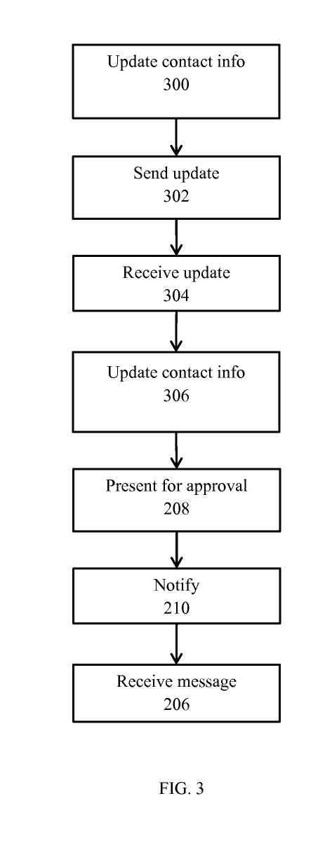

Referring now to FIG. 3, assuming user A approves contact B's request and rejects contact C's request, the following may occur. User A's contact management application has a contact update flag that indicates contact B is to be alerted of updates to user A's contact information and either has a negative contact update flag indicating contact C is not to be alerted of updates to user A's contact information or has no flag associated with contact C.

In block 300, user A may subsequently update her contact information. Updating may comprise: adding new contact information, deleting contact information or replacing contact information. In block 302, upon saving her updated contact information in her contact management application, the contact management application may either prompt user A to approve of communicating updated contact information to approved contacts (those contacts having a contact update flag set) or automatically do so without a prompt. The contact management application determines all contacts that are approved and disseminates an update to those contacts' contact management applications.

Now from the perspective of user A having received an update from another contact (which will be similar to a contact receiving an update from user A), in block 304, when user A's contact management application receives an update from another contact (i.e., one that is using her own contact management application and has just disseminated an update), in block 306, user A's contact management application may automatically update the locally stored contact information for that contact. Alternatively, the contact management application may request permission from contact A to process the update prior to updating the locally stored contact information for that contact. The locally stored contact information may be resident within the contact management application or in a third party address book.

In an alternate embodiment, contacts need not operate their own contact management applications in order to request and receive updates from user A. For example, contact B may be using a proprietary address book that is not operable to communicate with user A's contact management application. In this case, the contact management application (of user A) may include an interface to a third-party messaging medium (SMS, email, instant messaging application) and can receive requests using such a medium. For example, contact B could manually send a SMS to user A in accordance with a known format that is readable by user A's contact management application. For example, the SMS may be formatted as “Request:update”, which is readable by the contact management application which can associate the sending phone number with contact B and flag that contact B is to be alerted of contact information updates.

User A's contact management application may further store that updates to contact B should be sent via the messaging medium from which the request was received. In the present example, updates can also be sent by SMS, such as a SMS formatted as “Contact info update:user A. New phone number 555-555-5555”. It will be appreciated that any such format and any such medium may be substituted.

In any event, when user A's contact management application is updated by user A, it disseminates an update to contact B (and any other contacts for which the update flag is set; but not to contacts for which the update flag is not set). The means of dissemination may be dependent upon whether contact B has a respective contact management application or operates a third party address book. This can be determined based on the request received from contact B for updates. If that request was sent via contact B's contact management application, then the update response should be sent to contact B's contact management application. If, however, the request was sent through a third party communications medium, the response can be sent either through such medium or through an accepted protocol, such as SMS or email.

The contact management application further enables user A to modify the update flag or manually set or remove the update flag for any user. This could be performed using a suitable user interface.

In an additional aspect, the contact management application may suppress requests and updates in particular conditions. For example, suppression may be enabled when the computing device is in a roaming state and would incur fees to make requests and updates. Such behaviour may be configurable by the user.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

We claim:

1. A system for managing contacts on a computing device, the computing device comprising a processor and memory, the memory storing computer instructions which when executed by the processor cause the processor to provide a contact management application, the computing device further in network communication with one or more additional computing devices, the contact management application configured to communicate contact information updates to selected ones of the additional computing devices corresponding to contacts for which a user of the computing device has approved for the contact information updates to be sent.

2. The system of claim 1, wherein the contact management application provides the user with the capability of signalling the approval for a particular one of the contacts in response to a request for contact information updates from the particular one of the contacts.

3. The system of claim 2, wherein the contact management application stores a contact update flag for approved users.

4. The system of claim 1, wherein the contact information updates are sent in a proprietary format for reading by a corresponding contact management application provided on the additional computing devices.

5. The system of claim 1, wherein the contact information updates are sent by email.

6. The system of claim 1, wherein the contact information updates are sent by SMS.

7. The system of claim 1, wherein the contact management application is configured to communicate a request to receive contact information updates from selected ones of the contacts as signalled by the user.

8. The system of claim 7, wherein the contact management application is configured to notify the user of whether the selected ones of the contacts approved the request.

9. The system of claim 7, wherein the contact management application is configured to receive updated contact information from a contact that has approved sending an update to the user and correspondingly update locally stored contact information corresponding to the contact.

10. The system of claim 9, wherein the locally stored contact information is stored in the contact management application.

11. The system of claim 9, wherein the locally stored contact information is stored in an address book.

12. The system of claim 1, wherein the contact management application determines whether the computing device lists contact information for a contact corresponding to the one of the additional computing device from which a contact information update request was received, and communicates a reverse request for contact information updates to the one of the additional computing devices if the contact information is not listed in the computing device.

13. The system of claim 12, wherein the contact management application further lists the contact information for the contact if the contact information for the contact was previously unlisted and the user approves the contact information update request.

14. A method for managing contacts on a computing device, the computing device comprising a processor and memory, the memory storing computer instructions which when executed by the processor cause the processor to with one or more additional computing devices, the method comprising:
a. receiving a request from at least one additional computing device in network communication with the computing device, the at least one additional computing device corresponding to at least one contact;
b. enabling a user of the computing device to selectively approve of communicating contact information updates to the at least one additional computing device; and
c. communicating contact information updates to the selected ones of the additional computing devices corresponding to contacts for which a user of the computing device has approved for the contact information updates to be sent.

15. The method of claim 14, wherein the user signals the approval for a particular one of the contacts in response to a request for contact information updates from the particular one of the contacts.

16. The method of claim 15, further comprising storing on the computing device a contact update flag for approved users.

17. The method of claim 14, wherein the contact information updates are sent in a proprietary format for reading by the additional computing devices.

18. The method of claim 14, wherein the contact information updates are sent by email.

19. The method of claim 14, wherein the contact information updates are sent by SMS.

20. The method of claim 14, further comprising communicating a request to receive contact information updates from selected ones of the contacts as signalled by the user.

21. The method of claim 20, further comprising notifying the user of whether the selected ones of the contacts approved the request.

22. The method of claim 20, further comprising receiving updated contact information from a contact that has approved sending an update to the user, and updating locally stored contact information corresponding to the contact.

23. The method of claim 11, wherein the locally stored contact information is stored in a contact management application.

24. The method of claim 22, wherein the locally stored contact information is stored in an address book.

25. The method of claim 12, wherein the contact management application determines whether the computing device lists contact information for a contact corresponding to the one of the additional computing device from which a contact information update request was received, and communicates a reverse request for contact information updates to the one of the additional computing devices if the contact information is not listed in the computing device.

26. The system of claim 13, wherein the contact management application further lists the contact information for the contact if the contact information for the contact was previously unlisted and the user approves the contact information update request.
